(19) United States
(12) Patent Application Publication
(10) Pub. No.: US 2012/0111644 A1
(43) Pub. Date: May 10, 2012

(54) ELECTRONIC BELT SCALE WITH MULTIPLE ACCUMULATIVE QUANTITIES

(75) Inventor: Da Li, Jiangsu (CN)

(73) Assignee: SAIMO ELECTRIC CO., LTD., Jiangsu (CN)

(21) Appl. No.: 13/384,537

(22) PCT Filed: Mar. 16, 2010
(86) PCT No.: PCT/CN2010/071082

§ 371 Date: Jan. 17, 2012

(30) Foreign Application Priority Data
Jul. 29, 2009 (CN) 200910182017.2

(51) Int. Cl. G01G 13/08

(52) U.S. Cl. 177/52

(57) ABSTRACT

An electronic belt scale with multiple accumulative quantities comprises: multiple groups of weighing units (12), an accumulator (10) and a speed measuring sensor (11). The weighing unit (12) includes a weighing sensor bracket (5), a cantilever type weighing sensor (4) provided on the weighing sensor bracket (5), a support (2) hinged at the suspending arm side of the weighing sensor (4), and a limiting body (9) connected with the weighing sensor bracket (5) under the weighing sensor (4). A weighing signal wire of the weighing sensor (4) and a speed measuring signal wire of the speed measuring sensor (11) are connected with the accumulator (10). Weighing signals and speed signals are accumulated and combined to one group of main accumulative quantities and at least two groups of auxiliary accumulative quantities by the accumulator (10) so as to display and control the main and the auxiliary accumulative quantities of weight.

### I. TECHNICAL FIELD

The present invention relates to electronic belt scale with multiple accumulative quantities, which is, in particular, suitable for online accurate and reliable weight measurement for materials conveyed continuously by belt conveyer.

### II. TECHNICAL BACKGROUND

At present, the electronic belt scales for continuous weighing of materials on belt conveyers include single lever, double levers, whole suspension type and so on; and these electronic belt scales, when used on the conveyors, can meter alone or in pairs or in the form of measurement system composed of several scales. Presently, this metering system for electronic belt scales measures by incorporating all weighing signals into an accumulator or by separately incorporating the weighing signals from each weighing sensor into the accumulator for cumulative operation, and in both cases, the accumulator displays and utilizes only one accumulative quantity. There are the drawbacks that the electronic belt scales provide less weighing information and are unfavorable for monitoring and utilization. Moreover, in the whole suspension type single idler weighing unit of the electronic belt scale in the measurement system, the idler bracket is fixedly connected with the weighing sensor, as is inconvenient for adjustment during installation. This structure has a certain internal stress when the scale is installed. Sometimes the internal stress can't be released very well, and over-positioning easily occurs, thus the accuracy of the final measurement result of the belt scale is affected.

### III. SUMMARY OF THE INVENTION

### Technical Problem

The purpose of the present invention is to provide an electronic belt scale with multiple accumulative quantities with compact structure, free of over-positioning and extra internal stress, as well as convenient for installation and debugging, and accurate in measurement.

### Technical Scheme

The present invention relates to an electronic belt scale with multiple accumulative quantities which includes an accumulator and speed measuring sensor, and further includes multiple groups of weighing units evenly distributed and fixedly installed on the frame of the conveyer. Each group of weighing unit includes a weighing sensor bracket located at the conveyer frame, and weighing sensor is provided on the weighing sensor bracket, and a support is hinged at the suspending arm side of the weighing sensor. The top of the support supports the idler bracket and the bottom is provided with a limiting body connected with the weighing sensor support. At the bottom of the weighing sensor bracket, there is a limiting bolt which passes through the bottom of the weighing sensor bracket and is connected with suspending arm side of the weighing sensor. The weighing signal wire of each weighing sensor and the speed measuring signal wire of speed measuring sensor are connected with the accumulator respectively. By software programming of accumulator, weighing signals and speed signals of each group are accumulated and combined to form multiple groups of accumulative quantities, so as to control weighing and display of the electronic belt scale in terms of one group of main accumulative quantities and at least two groups of auxiliary accumulative quantities.

The accumulator is a computer or electronic weighing display control instrument; the multiple groups of weighing units includes at least two groups; the end of the weighing sensor which is hinged with the support is cylindrical; at the bottom of the weighing sensor bracket there is equipped with tension bolt which is fixed to the bottom of the conveyer frame; the idler bracket includes flat shape idler structure, groove shape idler structure or V-shape idler structure; and a weighing sensor protection shield covering the weighing sensor is provided on the weighing sensor bracket respectively.

### Benefits

The present invention adopts a metering system consisting of multiple groups of weighing units, which are combined to extend the length of weighing zone and improve the weighing accuracy on one hand, and to produce multiple groups of accumulative quantities on the other hand. The accumulator accumulates the weighing signals from multipath weighing units and the speed signals from the speed measuring sensor through software programming, and combines them into multiple groups of accumulative quantities, implements redundant backup for the electronic belt scale with multiple accumulative quantities. When one group of accumulative quantity is abnormal, it will be immediately detected, isolated and controlled while the other group of accumulative quantity normally works, thus ensuring that the measurement of electronic belt scale maintains reliable. At the same time, the conveyer system needs not to stop and the system still can normally work. The present invention can achieve multiple groups of accumulative quantities simultaneously, provides the function of redundant backup, high reliability and exact measuring accuracy; and the weighing unit is of simple structure, suitable for a large range of bandwidth, the weighing sensor is free of over-positioning, and the weighing sensor bracket has a firm structure featuring simple and easy installation and debugging, less maintenance, most suitable for online accurate and reliable weight measurement for continuously delivered material on belt conveyer, long service life and extensive practicability.

### IV. DESCRIPTION OF DRAWINGS

FIG. 1 is the structural schematic diagram of electronic belt scale with multiple accumulative quantities in the invention.

FIG. 2 is the structure diagram of the weighing unit of the electronic belt scale with multiple accumulative quantities in the invention.

FIG. 3 is the enlarged view of the structure of the weighing sensor component of the electronic belt scale with multiple accumulative quantities in the invention.

FIG. 4 is the left view of FIG. 3.

In the figures, 1—idler bracket, 2—support, 3—weighing sensor protection shield, 4—weighing sensor, 5—weighing sensor bracket, 6—conveyer frame, 7—tension bolt, 8—limiting bolt, 9—limiting body, 10—accumulator, 11—speed measuring sensor, 12—weighing unit.

### V. DETAILED DESCRIPTION OF THE EMBODIMENTS

An example of the present invention is further described below with reference to the attached drawings:

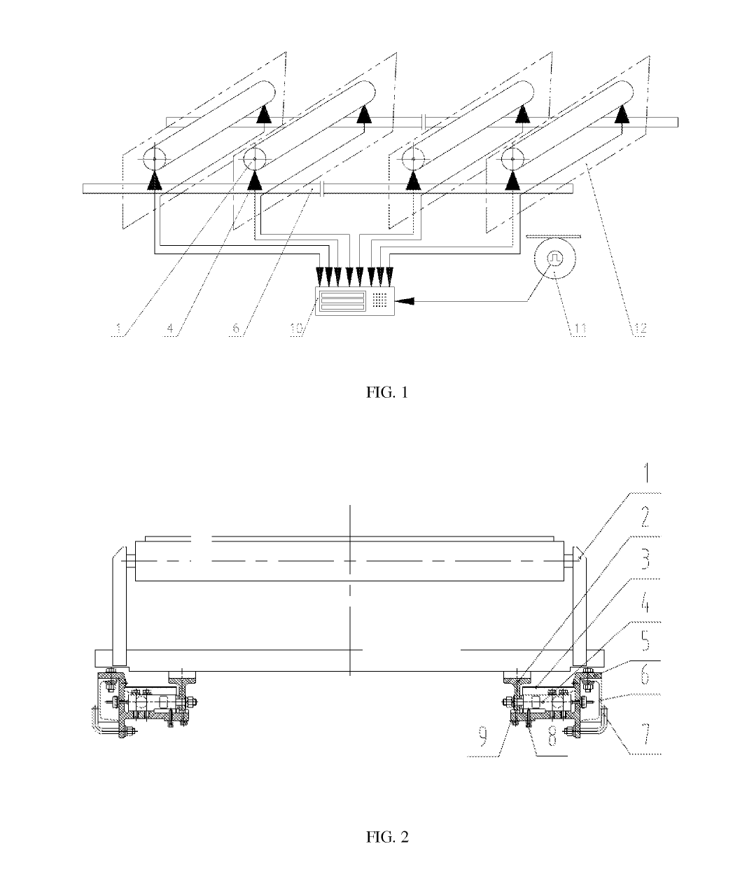

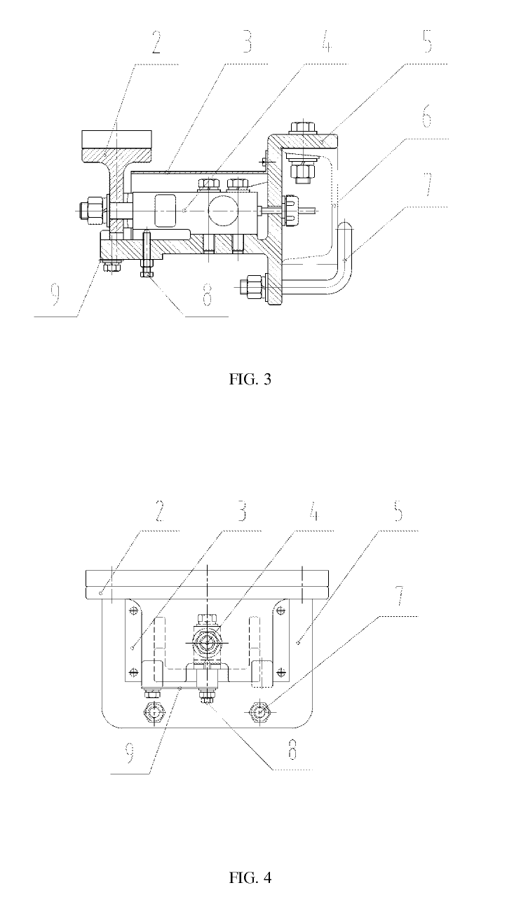

As shown in the figure, electronic belt scale with multiple accumulative quantities comprises multiple groups of weighing units (12) evenly distributed and fixedly installed on the conveyer frame (6), accumulator (10) and speed measuring sensor (11). Each group of weighing unit (12) is mainly composed of idler bracket (1), support (2), weighing sensor protection shield (3), weighing sensor (4), weighing sensor bracket (5), tension bolt (7), limiting bolt (8) and limiting body (9). The multiple groups of weighing units includes at least 2 groups. There are 4 groups as shown in FIG. 1. The multiple groups of weighing units may contain 3, 5, 6, 7 or 8 groups and so on according to the actual requirement. Each group of weighing unit (12) contains 2 weighing sensor brackets (5) fixed and installed on the left and right hands to the conveyer frame (6), respectively. To increase the fixing rigidity of the weighing sensor bracket (5) on the conveyer frame (6), tension bolt (7) fixed to the bottom of the conveyer frame (6) is installed at the bottoms of two weighing sensor bracket (5), respectively. Cantilever type weighing sensor (4) and weighing sensor protection shield (3) are fixed to each weighing sensor bracket (5), at the bottom of which, limiting bolt (8) and limiting body (9) are provided. The other end of the limiting body (9) is connected to the bottom of the support (2) which is hinged and installed to the suspending arm side of the weighing sensor (4). Idler bracket (1) is fixedly installed on the tops of the left and right supports (2).

Suspending arm side of the weighing sensor (4) is cylindrical, and hinged with the support (2), forming an whole suspension type support for idler bracket (1), thus eliminating the impact of over-positioning on the weighing sensor (4), resulting from the errors in installing the left and right weighing sensor brackets (5) at the front and rear of the conveyer frame (6); and the limiting bolts (8) under the weighing sensor bracket (5) are adjustable, providing overload protection for the weighing sensor (4). The limiting body (9) under the weighing sensor bracket (5) is connected to the weighing sensor bracket (5) at one end and fixedly connected to the support (2) at the other end. The limiting body (9) limits the rotary motion of the support (2) while allowing the support (2) to move slightly downward so that the combined lateral force on the weighing sensor (4) is close to zero, thereby ensuring that the weighing sensor (4) receives only the downward force. The idler bracket (1) of each group of weighing unit (12) is in a structural form of flat shape, groove shape or V-shape idler bracket; and for each group of weighing unit (12), the number of weighing sensors (4) is at least one according to the bandwidth requirement, arranged in the middle below the idler bracket (1). The weighing signal wire for each weighing sensor (4) and the speed measuring signal wire for speed measuring sensor (11) are connected with the accumulator (10), respectively. By controlling the accumulator (10) through software programming, accumulate and combine the weighing signals of multipath weighing sensors (4) and the speed signals of the speed measuring sensors (11) into multiple groups of accumulative quantities so that the electronic belt scale gains one group of main accumulative quantities and at least two groups of auxiliary accumulative quantities. The accumulator (10) can be either based on computer or electronic weighing display control instrument, and the example in the figure shows an electronic weighing display control instrument with three groups of display windows.

The main accumulative quantities comprises the weighing units in all groups, provides long weighing zone and high metering accuracy, and the main accumulative quantities takes metering when the belt scale normally works. The auxiliary accumulative quantities comprise the weighing units (12) in each group alone. Make real-time online comparison for the auxiliary accumulative quantities obtained in each group of weighing units (12) through software. If a group of auxiliary accumulative quantities is found beyond the range of setting value, the accumulator (10) makes judgment for the weighing sensor (4) in the weighing units (12) of that group of auxiliary accumulative quantities, determines if the weighing sensor (4) in the group is defective, isolates and controls the weighing units (12) of the defective weighing sensor (4) in the group. On the other hand, another group of normal auxiliary accumulative quantities automatically takes the place of the main accumulative quantities, the belt scale continues to work and the system continues to run, thus ensuring that the measurement of the system maintains reliable even when the weighing sensor of the electronic belt scale is defective while the belt conveyer system needs not stop. This greatly improves the reliability of the operation of the electronic belt scale and metering accuracy, and avoids faults of weighing sensors and inaccurate, measurement which will cause economic loss.

1. An electronic belt scale with multiple accumulative quantities, including an accumulator (10) and a speed measuring sensor (11), characterized in that: it also includes multiple groups of weighing units (12) evenly distributed and fixedly installed on the conveyer frame (6), each weighing unit (12) includes a weighing sensor bracket (5), cantilever type weighing sensor (4) is provided on the weighing sensor bracket (5), the suspending arm side of the weighing sensor (4) is hinged with a support (2), the top of the support (2) supports the idler bracket (1), the bottom of the support (2) is equipped with a limiting body (9) connected with the weighing sensor bracket (5), a limiting bolt (8) passing through the bottom of the weighing sensor bracket (5) and in contact with the suspending arm side of the weighing sensor (4) is arranged at the bottom of the weighing sensor bracket (5); and the weighing signal wire for each weighing sensor (4) and the speed measuring signal wire for speed measuring sensor (11) are respectively connected to the accumulator (10) which accumulates each group of weighing signal and speed signal into multiple groups of accumulative quantities by software programming to the accumulator (10), forming weighing and display control on the electronic belt scale in terms of one group of main accumulative quantities and at least two groups of auxiliary accumulative quantities.

2. The electronic belt scale with multiple accumulative quantities according to claim 1, characterized in that the accumulator (10) is a computer or display control instrument for electronic weighing.

3. The electronic belt scale with multiple accumulative quantities according to claim 1, characterized in that the multiple groups of weighing units (12) includes at least two groups.

4. The electronic belt scale with multiple accumulative quantities according to claim 1, characterized in that the end of the weighing sensor (4) hinged with the support (2) is cylindrical.

5. The electronic belt scale with multiple accumulative quantities according to claim 1, characterized in that on the bottom of the weighing sensor bracket (5), there are tension bolts (7) which are fixed to the bottom of the conveyer frame (6).

6. The electronic belt scale with multiple accumulative quantities according to claim 1, characterized in that the idler bracket (1) has flat shape idler structure, groove shape idler structure or V-shape idler structure.

7. The electronic belt scale with multiple accumulative quantities according to claim 1, characterized in that a weighing sensor protection shields (3) covering the weighing sensor (4) are provided on the weighing sensor bracket (5) respectively.
